(19) United States
(12) Patent Application Publication
(10) Pub. No.: US 2014/0173157 A1
(43) Pub. Date: Jun. 19, 2014

(54) COMPUTING ENCLOSURE BACKPLANE WITH FLEXIBLE NETWORK SUPPORT

(71) Applicant: MICROSOFT CORPORATION, Redmond, WA (US)

(72) Inventors: Mark Edward Shaw, Sammamish, WA (US); Kushagra V. Vaid, Sammamish, WA (US); David A. Maltz, Bellevue, WA (US); Parantap Lahiri, Redmond, WA (US)

(73) Assignee: Microsoft Corporation, Redmond, WA (US)

(21) Appl. No.: 13/715,558

(22) Filed: Dec. 14, 2012

(51) Int. Cl. G06F 13/40

(52) U.S. Cl. CPC G06F 13/40
USPC 710/305

(57) ABSTRACT

Computing unit enclosures are often configured to connect units (e.g., server racks or trays) with a wired network. Because the network type may vary (e.g., Ethernet, InfiniBand, and Fibre Channel), such enclosures often provide network resources connecting each unit with each supported network type. However, such architectures may present inefficiencies such as unused network resources, and may constrain network support for the units to a small set of supported network types. Presented herein are enclosure architectures enabling flexible and efficient network support by including a backplane comprising a backplane bus that exchanges data between the units and a network adapter using an expansion bus protocol, such as PCI-Express. By shifting the point of network specialization from the enclosure to the network adapter, such architectures may be compatible with network adapters of any network type that communicate with the units according to a widely supported and network-type-independent expansion bus protocol.

### BACKGROUND

Within the field of computing, many scenarios involve a computing unit enclosure configured to store a set of computational units, such as server racks or blades, each of which may store one or more computers. In addition to providing a physical storage structure, the enclosure may provide various physical, electrical, and electronic resources for the units, such as climate regulation, power distribution and backup reserves, and communication with one or more wired or wireless networks. In particular, the provision of wired network resources may involve a network resource that connects with a network and provides network connectivity to one or several of the units in the enclosure. As a first example, the enclosure may feature a single network connector to connect to a wired network, and may distribute the connection from the single network connector with each unit. As a second example, the enclosure may feature a network switch connecting to the wired network, and may provide switched network connectivity to network interface controllers provided with each unit. These techniques for sharing network resources may be more cost- and energy-effective and easier to manage than providing a separate set of network resources for each unit and/or computer.

However, the units within the enclosure may utilize a variety of wired network types, such as Ethernet, InfiniBand, Fibre Channel, and various types of fiber optic networks. Each network type may feature a particular set of resources, such as a distinctive type of connector, a distinctive type of cabling, a particular class of network adapter and/or network interface controller, and a particular network protocol. A set of network resources provided by the enclosure may be specialized for a particular network type (e.g., specialized to exchange data according to a particular network protocol). Moreover, different units may be configured to connect with different types of networks; e.g., a first unit may include an Ethernet network interface controller, and a second unit may include an InfiniBand network interface controller.

In order to support multiple network types, the enclosure may provide a multitude of network resources for each supported network type, and may connect each unit within the enclosure to each set of network resources. Thus, for an enclosure featuring M units and supporting N network types, the enclosure may include M*N sets of connecting resources (e.g., M sets of Ethernet cables or circuits providing connectivity for each unit to an Ethernet network and specialized for exchanging data via an Ethernet network protocol, and also M sets of InfiniBand cables or circuits providing connectivity for each unit to an InfiniBand network and specialized for exchanging data via the Sockets Direct Protocol for InfiniBand networks).

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While designing an enclosure to support a variety of network types, it may be undesirable to provide multiple sets of network resources to connect respective units with each network type. Such architectures typically result in at least some network types remaining unutilized, thus creating inefficiencies of cost, equipment, energy, and administration. Additionally, configuring the enclosure to provide network resources only a particular set of network types limits the compatibility of the enclosure with other network types, including those that may be provided in the future. For at least these reasons, the architectural decision of configuring an enclosure to provide several distinct sets of network resources for specific network types may reduce the efficiency, cost-effectiveness, and flexibility of the enclosure.

Presented herein are alternative enclosure architectures that provide network support to the units that are not restricted to particular network types. Rather than providing network resources for particular network types, the enclosure may provide a backplane comprising a backplane bus that is configured to exchange data not according to a network protocol, but according to an expansion bus protocol, such as the Peripheral Component Interconnect Express (PCI-Express) standard. The backplane bus may therefore connect two or more units with one or more network adapters using an expansion bus protocol that is supported by a wide variety of network adapters. Moreover, the backplane may include resources additional resources to support connectivity with a variety of network adapters, such as a network adapter switch providing multi-root input/output virtualization (MR-IOV) that enables several units and/or computers to share a single network adapter. Such architectures may shift the point of network type specialization from the enclosure to the network adapter, and may provide connectivity resources in a network-type-independent manner using an expansion bus protocol that is supported by a wide variety of such network adapters, including network adapters for network types that have not yet been devised.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary architecture of a chassis storing a set of servers and providing a variety of network resources supporting a variety of network types.

FIG. 2 is a first illustration of an exemplary architecture of a computing unit enclosure including a backplane connecting respective units with a network adapter via a network-type-independent backplane bus in accordance with the techniques presented herein.

FIG. 3 is a second illustration of an exemplary architecture of a computing unit enclosure including a backplane connecting respective units with a network adapter via a network-type-independent backplane bus in accordance with the techniques presented herein.

FIG. 4 is an illustration of an exemplary backplane architecture connecting respective units with a different network via a different network interface controller of a network adapter.

FIG. 5 is an illustration of an exemplary backplane architecture connecting respective units with a network adapter via a set of bus lanes.

FIG. 6 is an illustration of an exemplary backplane architecture featuring a network adapter switch configured to share a network adapter with multiple units via a multi-root input/output virtualization technique.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. Introduction

Within the field of computing, many scenarios involve an enclosure of a set of computational units storing a set of computing devices, such as a set of servers, workstations, storage devices, or routers. The enclosure may provide a physical structure for storing, organizing, and protecting the computational units, and may also provide other resources, such as regulation of the temperature, humidity, and airflow within the enclosure; distribution of power among the devices; and reserve power supplies, such as an uninterruptible power supply (UPS), in case the main power supply fails. In addition, the enclosure may provide connectivity to a wired or wireless network through a set of network resources. As a first example, the enclosure may provide an external network port, to which a wired network may be connected, and internal cabling or circuitry to connect the network port with each computational unit. As a second example, the enclosure may provide a network switch that provides direct communication among the computational units and, when connected with a network, provides network connectivity to each of the computational units. In this manner, the enclosure may facilitate network connectivity among the computational units in a more efficient manner than providing a complete, dedicated set of network resources for each unit (e.g., each unit having an individual network adapter and network port).

However, the provision of network resources within an enclosure may present difficulties in view of the variety of networks with which the computational units may be connected, such as Ethernet networks, InfiniBand networks, Fibre Channel networks, and various types of fiber optic networks. Each network type may involve a particular set of network resources, such as a particular type of network connector; a particular type of cabling and/or circuitry (e.g., light-conveying cabling in a fiber optic network); and network components that are configured to exchange data according to a particular network protocol (e.g., an Ethernet protocol for Ethernet networks, and a Sockets Direct Protocol for InfiniBand networks). Moreover, a user may wish to provide a set of units configured to communicate with a plurality of networks and/or network adapters presenting different network types. In order to facilitate such flexibility, some enclosure architectures may provide a set of network resources for each computing unit and each network type. For example, an enclosure configured to support four units may provide four sets of Ethernet network cables and/or circuitry; four sets of InfiniBand network cables and/or circuitry; and four sets of Fibre Channel network cables and/or circuitry. The user may connect each unit to the network resources for the desired network type.

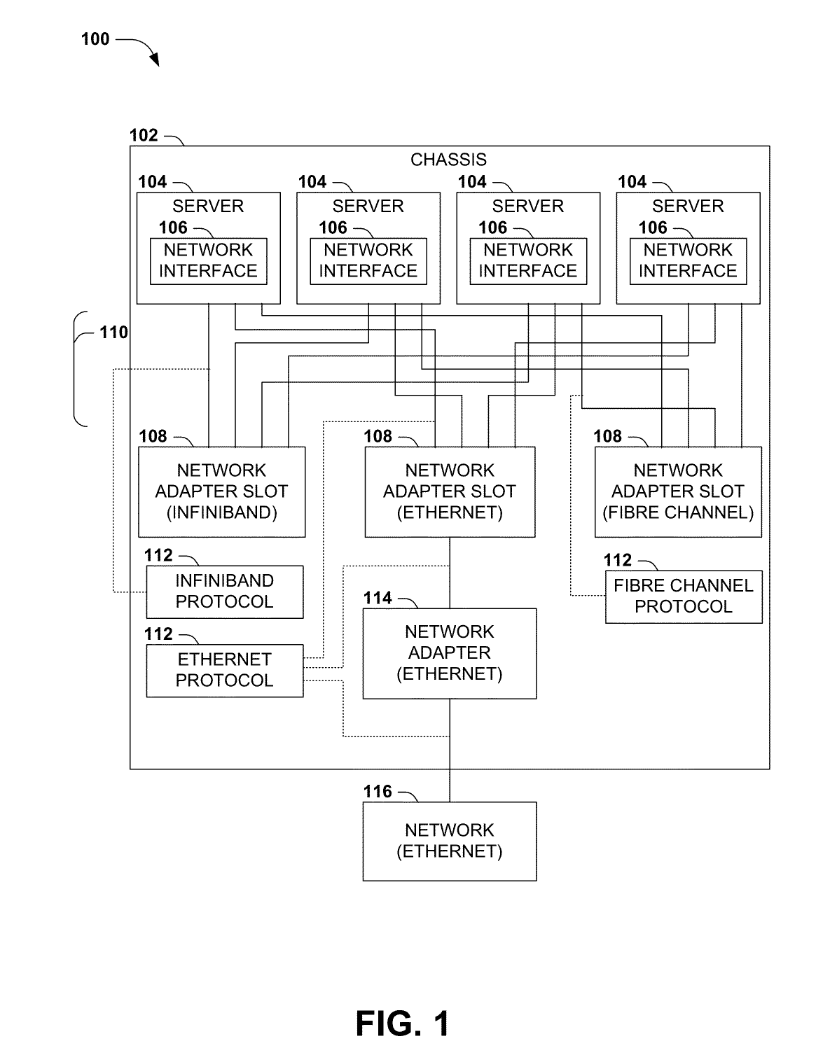

FIG. 1 presents an illustration of an exemplary scenario 100 featuring a chassis 102 supporting four servers 104. Each server 104 may have a network interface 106 of a particular network type, and the chassis 102 may provide network resources to connect the servers 104 to one or more networks 116. Moreover, the chassis 102 may be compatible with a set of network types, such as Ethernet networks, InfiniBand networks, and Fibre Channel networks, such that the user may choose any of these network types and may connect the servers 104 with the network 116 using the corresponding set of resources. For example, the chassis 102 may include a set of network adapter slots 108 specialized for each network type, each connectible with a type of network adapter 114 provided by the user. Moreover, the network interfaces 106 of respective servers 104 may provide a set of connections 110 between each network adapter slot 108 and each server 104 (e.g., dedicated cabling that is connected to each network adapter slot 108 and available for connection to the server 104 via a network interface 106 of the corresponding network type). Moreover, the connections 110 and network adapter slots 108 may be configured to exchange data according to the network protocol 112 of the network type (e.g., a first set of components configured to exchange data according to an Ethernet protocol for an Ethernet network type, and a second set of components configured to exchange data according to a Sockets Direct Protocol for an InfiniBand network type). A user may opt to connect the servers 104 to an Ethernet network 116 by inserting an Ethernet network adapter 114 into the Ethernet network adapter slot; providing a set of servers 104 comprising Ethernet network interfaces 106; and connecting each server 104 to the network adapter slot 108 via the set of connections 110 for Ethernet networks (e.g., Ethernet cabling mounted within the chassis 102 for each server 104). In this manner, the architecture of the chassis 102 provides network resources that are compatible with a variety of network types.

However, the compatibility provided by the chassis 102 in the exemplary scenario 100 of FIG. 1 entails some undesirable inefficiencies and restrictions. As a first example, in a large number of scenarios, some of the network resources remain unutilized, such as the network resources for the InfiniBand and Fibre Channel network types in the exemplary scenario 100 of FIG. 1. While unutilized, these network resources occupy space within the chassis 102 (e.g., as excess network connectors, cabling, circuitry, and/or network adapter slots 108), may raise the cost of the chassis 102, and/or may consume energy (e.g., the network adapter slots 108 may consume energy even if unoccupied). As a second example, the network resources within the chassis 102 are only capable of supporting the selected set of network types. Unless the network resources are swappable, the chassis 102 may provide no features for other network types, including future network types that are devised after the manufacturing of the chassis 102. This chassis architecture therefore creates inefficiencies and restricts the range of options of compatible network types.

### B. Presented Techniques

It may be appreciated that the disadvantages evident in the exemplary scenario 100 of FIG. 1 arise from the specialization of network resources (including connections 110 and network adapter slots 108) for particular network types and/or network protocols 112. That is, if the point of network specialization arises at the network interfaces 106 provided by the servers 104, then the network resources connecting the network interfaces 106 to the network 116 have to be selected in view of a particular network type, thereby prompting the inclusion of a variety of such network resources for different network types. However, these disadvantages may be alleviated by shifting the point of network specialization from the network interfaces 106 of the servers 104 to actual network adapter 114 connected to the network 116, and providing a generalized, network-type-independent set of network resources connecting the network adapter 114 to the servers 104. Moreover, the network resources may exchange data using a generalized data protocol rather than a network protocol 112 that is specific to a particular network type. This shift enables generalized network resources to be used by each server 104 irrespective of the type of the network 116, the type of network adapter 114, and the network protocol 112 utilized therebetween. It may be further appreciated that expansion bus protocols may be a suitable selection, as many types of network adapters 114 connect with servers 114 and other types of computers as peripheral components placed in an expansion slot. For example, Peripheral Component Interconnect Express (PCI Express) is a widely recognized and supported expansion bus protocol, and a set of network resources provided within an enclosure that utilize PCI Express may share network resources and network connectivity with computational units, irrespective of the network type and the particular network adapter 114.

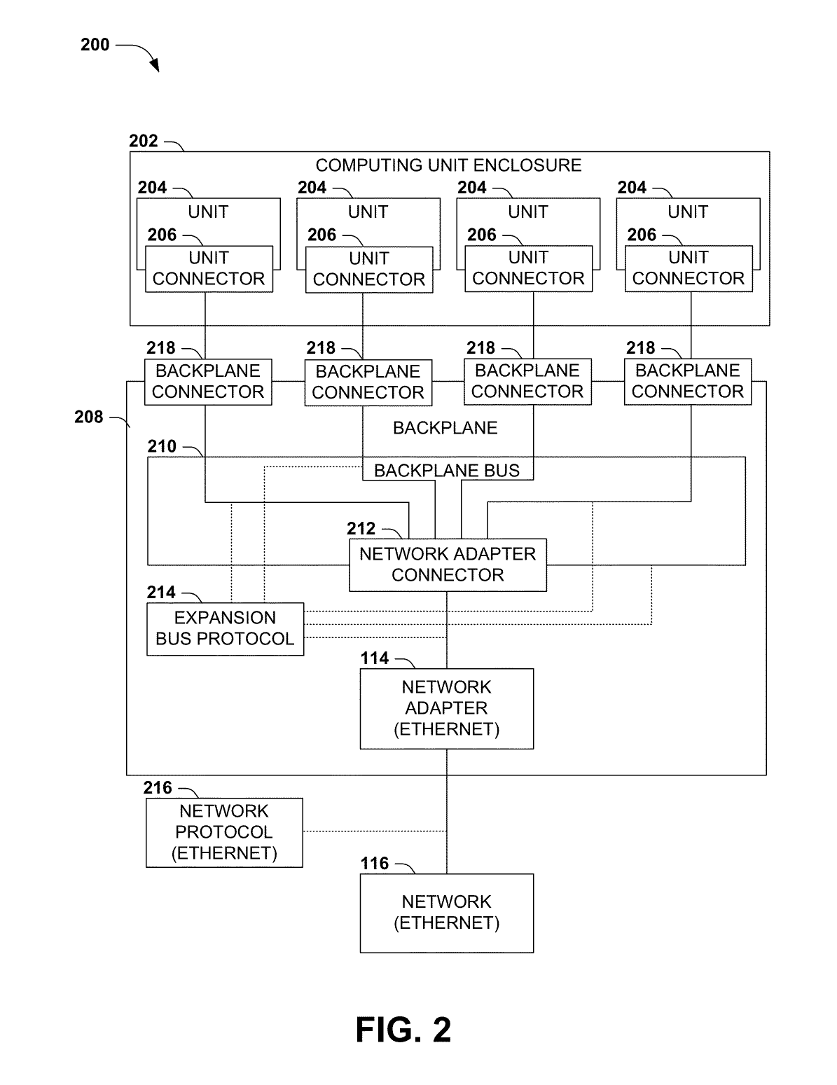

FIG. 2 presents an illustration of an exemplary scenario 200 featuring a computing unit enclosure 202 providing a set of units 204, such as a server rack or blade, storing one or more computing devices, and providing resources to connect the units 204 to a network 116 through a network adapter 114 (e.g., through a unit connector 206, such as a network port or expansion slot). In this exemplary scenario 200, a backplane 208 is provided featuring a set of backplane connectors 218 connectible with the unit connectors 206 of respective units 204; a network adapter connector 212 connectible with a network adapter 114; and a backplane bus 210 that connects respective unit connectors 206 to the network adapter connector 212. Notably, the backplane bus 210 utilizes an expansion bus protocol 214 rather than a network protocol 216, e.g., a PCI Express expansion bus rather than Ethernet connections. A user may choose to provide a set of units 204 having a free PCI Express expansion slot, and a network adapter 114 of a particular network type (e.g., an Ethernet network adapter) connected to a network 116 of the same network type. The network adapter connector 212 and/or network adapter 114 may translate between data exchanged with the units 204 via the backplane bus 210 using the expansion bus protocol 214, and data exchanged between the network adapter 114 and the network 116 using the network protocol 216. In this manner, the computing unit enclosure 202 may enable the units 204 to utilize any type of network adapter 114 that is compatible with the network adapter connector 212 (e.g., any type of PCI Express network adapter 114), irrespective of the type of network 116 to which the network adapter 114 connects.

### C. Exemplary Embodiments

FIG. 2 presents a first embodiment of the techniques presented herein, illustrated as an exemplary backplane 208 for a computing unit enclosure 202 comprising at least two units 204. The exemplary backplane 208 comprises at least two backplane connectors 218 respectively configured to connect to a unit connector of a unit. The exemplary backplane 208 also comprises a backplane bus 210 connected to the backplane connectors 218 and configured to exchange data with the backplane connectors 218 according to an expansion bus protocol 214. The exemplary backplane 208 also comprises a network adapter connector 212 (e.g., a network adapter expansion slot) that connects the backplane bus 210 and a network adapter 114, and that is configured to exchange data with the network adapter 114 according to the expansion bus protocol 214, rather than a network protocol 216. A user may utilize this computing unit enclosure 202 by connecting the unit connectors 206 of a set of units 204 to the backplane connectors 218; connecting a network adapter 114 of a selected network type, and supporting the expansion bus protocol 214, to the network adapter connector 212; and connecting the network adapter 114 to the network 116. This configuration achieves the provision of network connectivity to the units 204, where the unit resources and network resources (except the network adapter 114) are usable irrespective of the network type and/or network protocol 216 of the network 116.

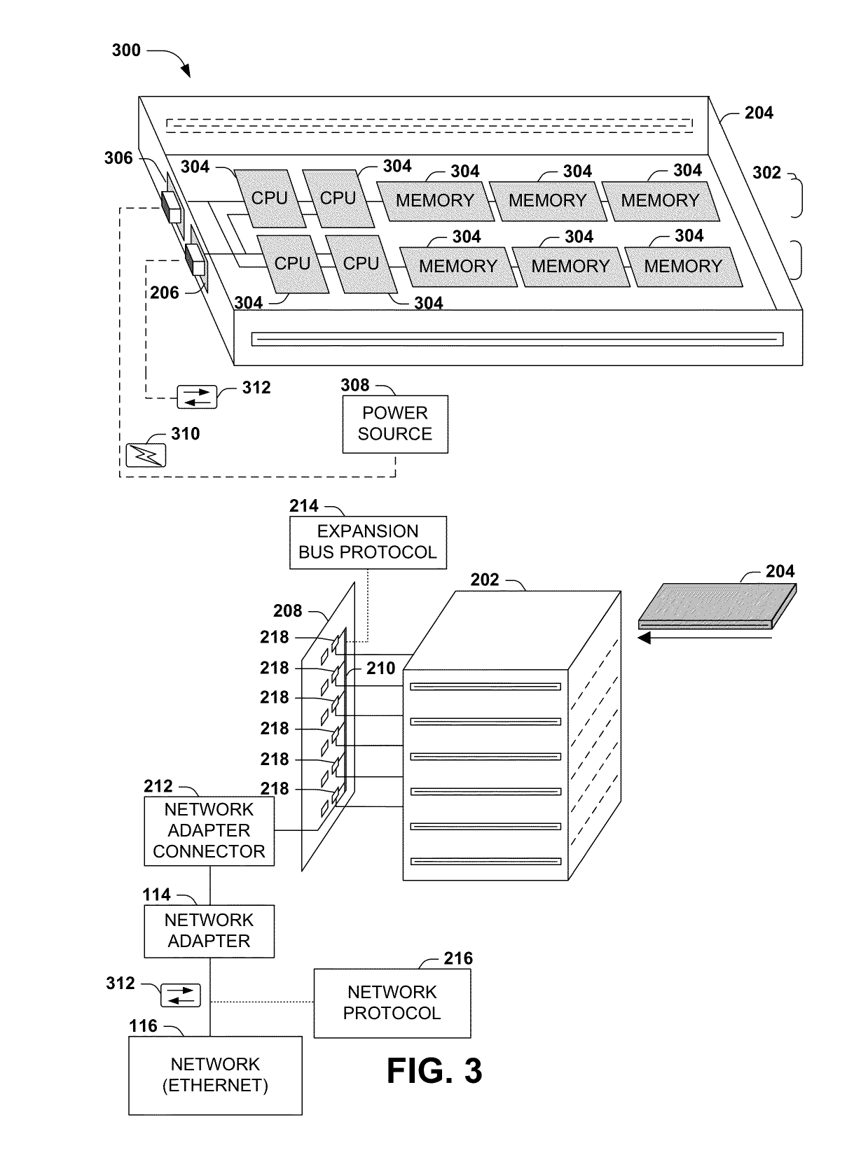

FIG. 3 presents a second embodiment of the techniques presented herein, illustrated as an exemplary computing unit enclosure 202 configured to provide network connectivity to a set of units 204 (illustrated in this exemplary scenario 300 as a “blade” server, wherein respective units 204 comprise a “blade” or “tray” of computing devices 302 operating within the computing unit enclosure 202). In this exemplary scenario 300, the unit 204 (illustrated in detail at top) includes two computing devices 302, each comprising a set of computational components 304 that interoperate to form a computer. Respective computing devices 302 are connected with both a power connector 306 through which the unit 204 receives power 310 from a power source 308 provided by the enclosure 202, and a unit connector 206 through which the computing devices 302 receive network connectivity 312. The unit 204 may be inserted into a slot of the computing unit enclosure 202, and the connectors on the back of the unit 204 may (manually or automatically, e.g., through a “blind mate” connection mechanism) connect with respective connectors on a backplane 208 positioned at the back of the computing unit enclosure 202. In particular, the backplane 208 features a set of backplane connectors 218 that connect with respective unit connectors 206 of the unit 204. The backplane 208 also comprises a network adapter connector 212 that is connectible with a network adapter 114, which, in turn, is connectible with a network 116 and exchanges data therewith according to a network protocol 216. The backplane 208 also comprises a backplane bus 210 interconnecting the backplane connectors 218 and the network adapter connector 212, and that is configured to exchange data according to an expansion bus protocol 214, such as PCI Express. By providing a suitable network adapter 114 connected to a network 116 and inserting one or more units 204, a user may utilize the computing unit enclosure 202 to share the network connectivity 312 of the network 116 among the units 204, and the internal components of the computing unit enclosure 202 may operate irrespective of the network protocol 216 used by the network adapter 114 to exchange data with the network 116. These and other embodiments may be devised by those of ordinary skill in the art while implementing the techniques and architectures presented herein.

### D. Variations

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary backplane 208 of FIG. 2 and the exemplary computing unit enclosure 202 of FIG. 3) to confer individual and/or synergistic advantages upon such embodiments.

D1. Scenarios

A first aspect that may vary among embodiments of these techniques relates to the scenarios wherein such techniques may be utilized.

As a first variation of this first aspect, many types of computing unit enclosures 202 may be equipped with the types of backplanes 208 described herein, such as racks, cabinets, banks, or “blade”-type enclosures, such as illustrated in the exemplary scenario 300 of FIG. 3. In addition, the computing unit enclosures 202 may store the units 204 in various ways, such as discrete and fully cased computing units, caseless units, portable units such as “blades” or “trays,” bare or bare motherboards comprising various sets of computational components 304 such as processors, memory units, storage units, display adapters, and power supplies. The computing unit enclosure 202 may also store the units 204 in various orientations, such as horizontally or vertically.

As a second variation of this first aspect, the techniques presented herein may be utilized with many types of computing devices 302, such as servers, server farms, workstations, laptops, tablets, mobile phones, game consoles, network appliances such as switches or routers, and storage devices such as network-attached storage (NAS) components.

As a third variation of this first aspect, a variety of network types, the enclosure architectures provided herein may be usable to share network resources provided by a variety of networks 116 involving many types of network adapters 114 and network protocols 216, such as Ethernet networks utilizing Ethernet network protocols; InfiniBand networks utilizing a Sockets Direct Protocol; Fibre Channel networks utilizing an Internet Fibre Channel Protocol (iFCP); and a fiber optic network utilizing a fiber Distributed Data Interface (FDDI) protocol.

As a fourth variation of this first aspect, the backplane bus 210 may utilize many types of expansion bus protocols 214 to exchange data between the network adapter 114 and the unit connectors 206 of the units 204, such as Peripheral Component Interconnect Express (PCI Express), Universal Serial Bus (USB), and Small Computer System Interface (SCSI). The unit connectors 206, backplane connectors 218, backplane bus 210, and network adapter connector 212 may be designed to operate according to a particular expansion bus protocol 214 that is supported by a selected network adapter 114.

As a fifth variation of this first aspect, the backplane bus 208 and various connectors may utilize many types of interconnection techniques, such as cabling and/or traces integrated with surfaces of the computing unit enclosure 202 and/or backplane 208. In some architectures, the traces may be designed with a trace length that is shorter than a trace repeater threshold (e.g., the length at which attenuation of the communication signal encourages the inclusion of a repeater to amplify the communication signal for continued transmission). Additionally, the connectors may comprise various connection techniques, such as manual insertion and release connectors or connectors that automatically couple without manual intervention, such as “blind mate” connectors. These and other variations in the architecture of the elements of the computing environment enclosure 202 may be selected and included while implementing the techniques presented herein.

D2. Backplane Bus Variations

A second aspect that may vary among embodiments of these techniques relates to the configuration of the backplane bus 210 provided on the backplane 208 to connect the units 204 with the network adapter connector 212.

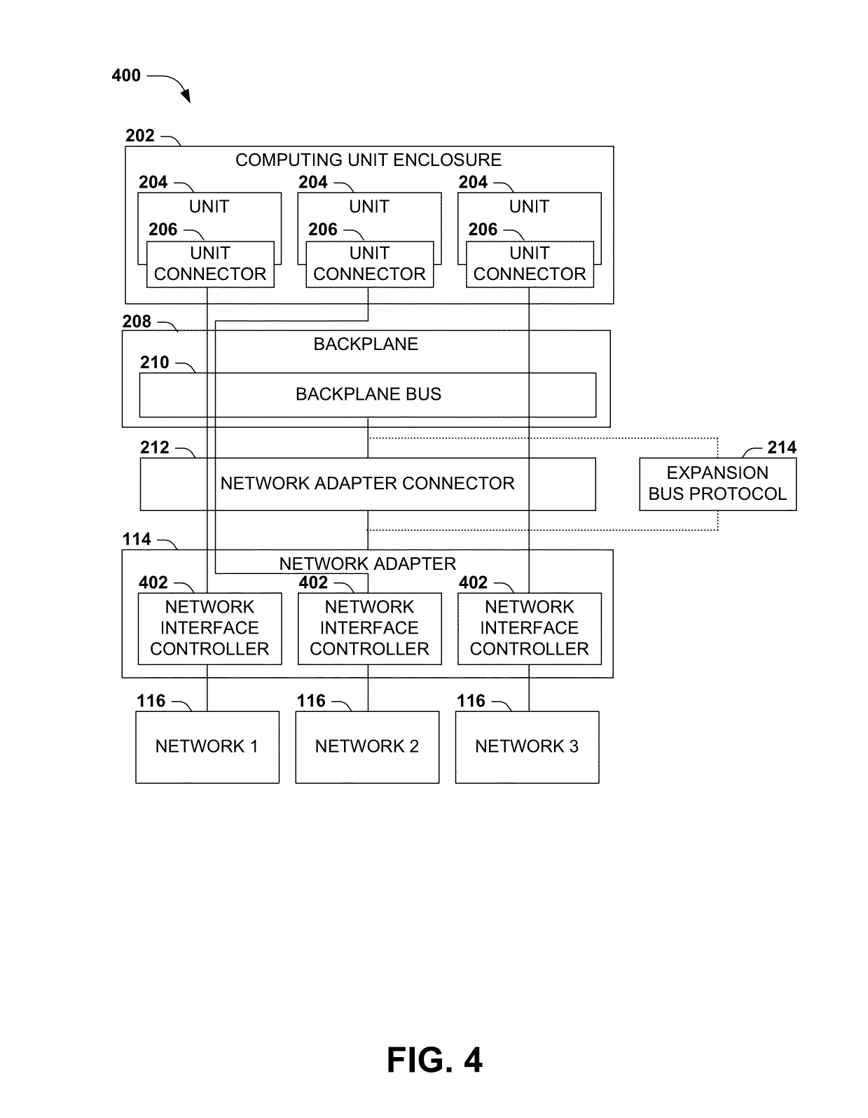

As in some scenarios, the network adapter 114 may comprise two or more network interface controllers, each respectively connected to a network 116. FIG. 4 presents an illustration of an exemplary scenario 400 featuring a first variation of this second aspect involving a computing unit enclosure 202 connecting a set of units 204 to a network adapter 114 via a backplane 208 such as provided herein. In this exemplary scenario 400, the network adapter 114 comprises three network interface controllers 402, each connected to a different network 116. The backplane 208 connects each unit 204 with a network 116 that is not connected to the other units 204, e.g., connecting each unit 204 with a different network 116 through a different network interface controller 402. Alternatively (not shown), two or more units 204 and/or computing devices 302 may be connected to different network interface controllers 402 that are each connected with the same network 116, thereby increasing the bandwidth to the network 116 by utilizing multiple network interface controllers 402 in parallel.

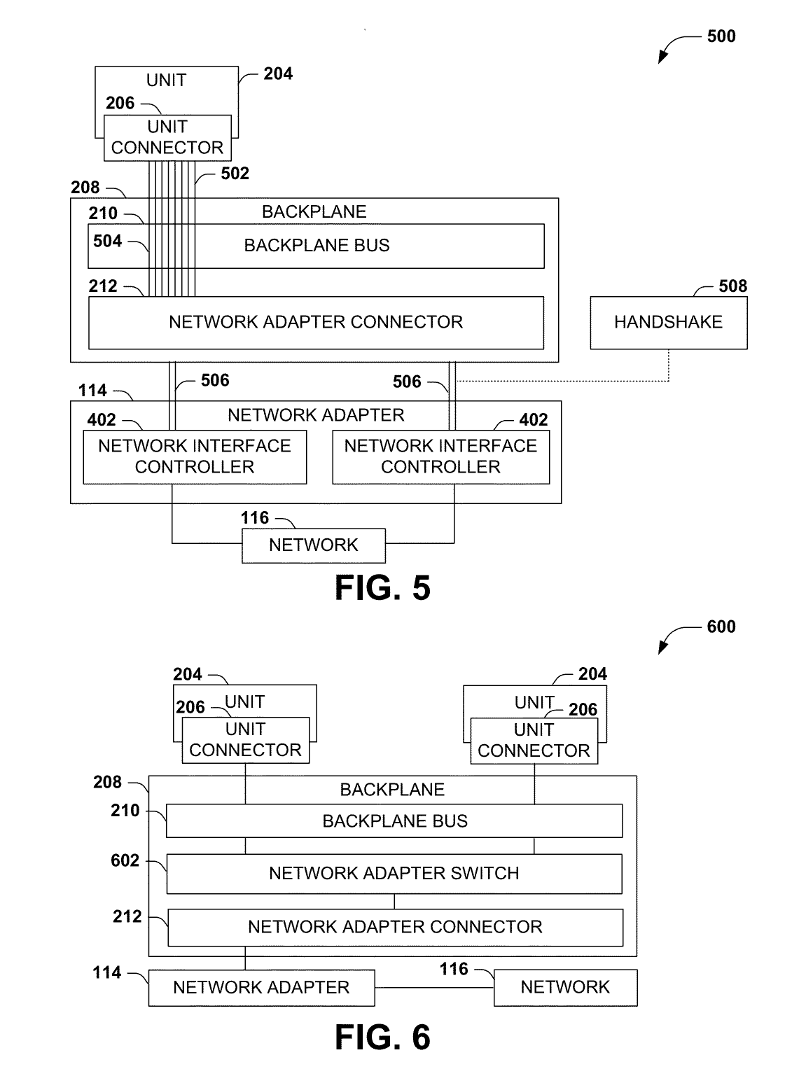

FIG. 5 presents an illustration of an exemplary scenario 500 featuring a second variation of this second aspect, wherein the backplane bus 210 connects the backplane connectors 218 and the network adapter connector 212 using a variable lane width. In this exemplary scenario 500, the backplane bus comprises a set of traces integrated with a surface of the backplane 208 that, when connecting the backplane connectors 218 and the network adapter connector 212 and optionally directly to a network interface controller 402, enable communication in parallel by concurrently sending data along each trace comprising a parallel “lane” of communication. Moreover, in some such architectures, the lane widths of the unit connectors 206, the backplane bus 210, and the network adapter 114 may vary. For example, and as illustrated in the exemplary scenario 500 of FIG. 5, the unit connector 206 and/or backplane connector 218 may provide at least two backplane connector lanes 502; the backplane bus may comprise at least two bus lanes 504; and the network adapter connector 212 may comprise at least one network adapter lane 506 (e.g., a “PCI 4x” network adapter 114 may provide four times as many network adapter lanes 506 as lower PCI ratings in order to provide additional bandwidth). Moreover, for network adapter connectors 212 comprising a plurality of network adapter lanes 506, each network adapter lane 506 may connect with a different network interface controller 402 of the network adapter 114 to support a set of network interface controllers 402 having a network interface controller count matching the network adapter lane count (e.g., a network adapter 114 providing multiple network interface controllers 402 to connect concurrently to different networks 116). Alternatively, multiple network adapter lanes 506 may connect to the same network interface controller 402 in order to expand the bandwidth of the network interface controller 402 with respect to the network 116.

In these and other scenarios, difficulties may arise if the lane counts of the backplane connector lanes 502, the bus lanes 504, and the network adapter lanes 506 differ. In some architectures, such differences may simply not be tolerated; e.g., units 204 and/or network adapters 114 may only be supported that have lane counts matching the lane count of the bus lanes 504. Alternatively, the backplane 208 may be configured to tolerate variances in lane counts. For example, upon connecting with a network adapter 114, the backplane bus 210 and/or network adapter connector 212 may be configured to determine a network adapter lane count of the network adapter lanes 506 of the network adapter 114, and negotiate an active lane count comprising a lesser of the network adapter lane count and a backplane bus lane count of the backplane bus lanes 504 of the backplane bus 210. This determination may be achieved during a handshake 508 performed while initiating the connection of the network adapter 114. These and other variations of the backplane 208 and backplane bus 210 may be devised by those of ordinary skill in the art while implementing the techniques presented herein.

D3. Additional Backplane Features

A third aspect that may vary among embodiments of these techniques relates to additional components that may be included on the backplane 208 and/or backplane bus 210 to provide additional features to the units 204 and computing unit enclosure 202.

As a first variation of this third aspect, the backplane connectors 218 of the backplane 208 may be configured to exchange data with the units 204 according to a network protocol 216 instead of the expansion bus protocol 214. For example, the unit connectors 206 of one or more units 204 may not comprise expansion bus protocol ports (e.g., PCI Express ports or USB ports), but, rather, may comprise network ports of network adapters provided on the units 204. In order to use such units 204 with the backplane bus 210 provided herein, the backplane connectors 218 may transform the network protocol data received from the units 204 to expansion bus protocol data that may be transmitted via the backplane bus 210, and vice versa. This configuration may provide greater flexibility in the types of units 204 that may be utilized with the computing unit enclosure 202.

FIG. 6 presents an illustration of an exemplary scenario 600 featuring a second variation of this third aspect, wherein the backplane 208 includes a network adapter switch 602 configured to enable two or more units 204 to share the network adapter 114. For example, while some network adapters 114 may support concurrent connections to multiple units 204 and/or computing devices 302, other network adapters 114 may only support a connection with one unit 204 and/or computing device 302 at a time. In order to provide concurrent access to such network adapters 114, the backplane 208 may include a network adapter switch 602 featuring component sharing of the network adapter 114 by at least two units 204. Many techniques and protocols may enable such sharing, including the multi-root input/output virtualization (MR-IOV) interface.

As a third variation of this third aspect, the backplane 208 may include a unit interconnect positioned between the backplane bus 210 and the network adapter connector 212 that enables direct communication among at least two units 204 and/or computing devices 302. For example, the unit interconnect may provide a direct, high-bandwidth communication channel between two or more units 204 that does not involve the network adapter 114, and therefore avoids the translation into and out of the network protocol 216 and other network features such as routing.

As a fourth variation of this third aspect, the computing unit enclosure 202 may be connectible with a second computing unit enclosure 202, e.g., in a multi-chassis cabinet wherein each chassis comprises a set of units 204. In order to enable the units 204 of respective chassis to interoperate, each computing unit enclosure 202 may provide a computing unit enclosure interconnect that connects with a second computing unit enclosure, thereby enabling communication between the units 202 of the respective chassis. These and other components may supplement the components of the backplane 208 and computing unit enclosure 202 provided herein to provide additional features that may be compatible with the techniques presented herein.

### E. Computing Environment

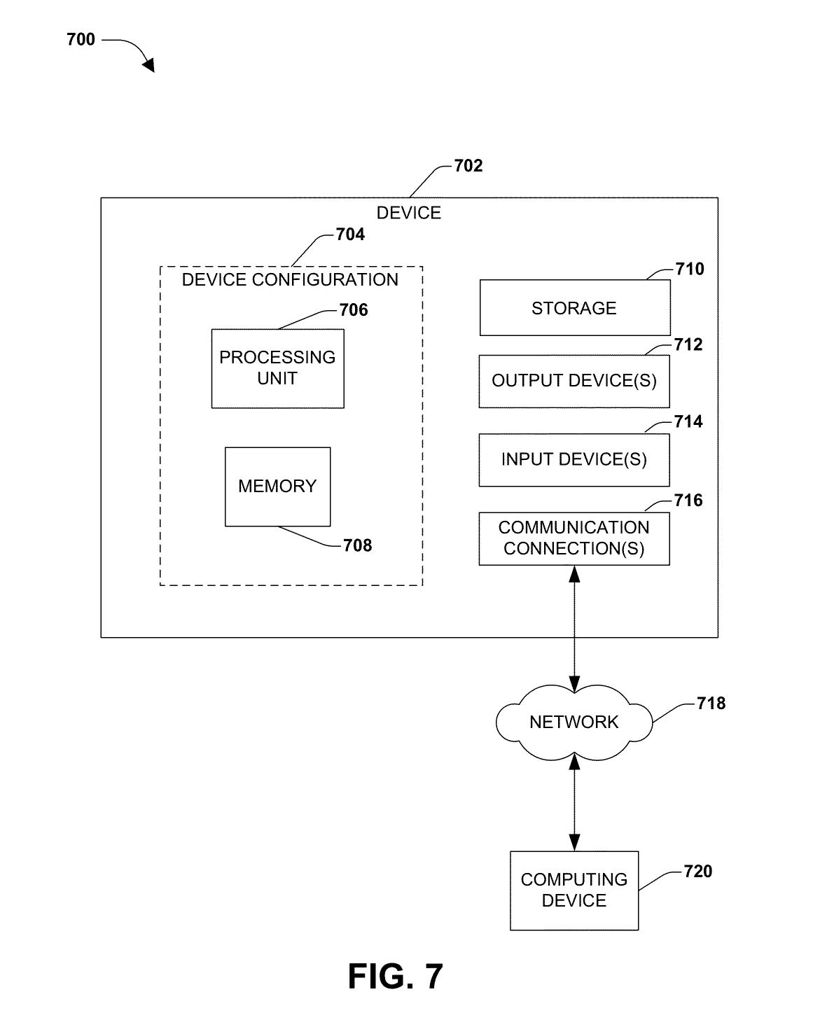

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 700 comprising a computing device 702 configured to implement one or more embodiments provided herein. In one configuration, computing device 702 includes at least one processing unit 706 and memory 708. Depending on the exact configuration and type of computing device, memory 708 may be volatile (such as RAM, for example), non-volatile (such as ROM, flash memory, etc., for example) or some combination of the two. This configuration is illustrated in FIG. 7 by dashed line 704.

In other embodiments, device 702 may include additional features and/or functionality. For example, device 702 may also include additional storage (e.g., removable and/or non-removable) including, but not limited to, magnetic storage, optical storage, and the like. Such additional storage is illustrated in FIG. 7 by storage 710. In one embodiment, computer readable instructions to implement one or more embodiments provided herein may be in storage 710. Storage 710 may also store other computer readable instructions to implement an operating system, an application program, and the like. Computer readable instructions may be loaded in memory 708 for execution by processing unit 706, for example.

The term “computer readable media” as used herein includes computer storage media. Computer storage media includes volatile and nonvolatile, removable and non-removable media implemented in any method or technology for storage of information such as computer readable instructions or other data. Memory 708 and storage 710 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 702. Any such computer storage media may be part of device 702.

Device 702 may also include communication connection(s) 716 that allows device 702 to communicate with other devices. Communication connection(s) 716 may include, but is not limited to, a modem, a Network Interface Card (NIC), an integrated network interface, a radio frequency transmitter/receiver, an infrared port, a USB connection, or other interfaces for connecting computing device 702 to other computing devices. Communication connection(s) 716 may include a wired connection or a wireless connection. Communication connection(s) 716 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 702 may include input device(s) 714 such as keyboard, mouse, pen, voice input device, touch input device, infrared cameras, video input devices, and/or any other input device. Output device(s) 712 such as one or more displays, speakers, printers, and/or any other output device may also be included in device 702. Input device(s) 714 and output device(s) 712 may be connected to device 702 via a wired connection, wireless connection, or any combination thereof. In one embodiment, an input device or an output device from another computing device may be used as input device(s) 714 or output device(s) 712 for computing device 702.

Components of computing device 702 may be connected by various interconnects, such as a bus. Such interconnects may include a Peripheral Component Interconnect (PCI), such as PCI Express, a Universal Serial Bus (USB), Firewire (IEEE 1394), an optical bus structure, and the like. In another embodiment, components of computing device 702 may be interconnected by a network. For example, memory 708 may be comprised of multiple physical memory units located in different physical locations interconnected by a network.

Those skilled in the art will realize that storage devices utilized to store computer readable instructions may be distributed across a network. For example, a computing device 720 accessible via network 718 may store computer readable instructions to implement one or more embodiments provided herein. Computing device 702 may access computing device 720 and download a part or all of the computer readable instructions for execution. Alternatively, computing device 702 may download pieces of the computer readable instructions, as needed, or some instructions may be executed at computing device 702 and some at computing device 720.

### F. Usage of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A backplane for a computing unit enclosure comprising at least two units respectively comprising a unit connector, the backplane comprising:
at least two backplane connectors respectively configured to connect to a unit connector of a unit;
a backplane bus connected to the backplane connectors and configured to exchange data with the backplane connectors according to an expansion bus protocol; and
a network adapter connector connecting the backplane bus and a network adapter, and configured to exchange data with the network adapter according to the expansion bus protocol.

2. The backplane of claim 1, the expansion bus protocol comprising a Peripheral Component Interconnect Express (PCI-Express) protocol.

3. The backplane of claim 1, the network adapter comprising at least two network interface controllers respectively connected to a network.

4. The backplane of claim 3, respective network interface controllers respectively connected with a network that is not connected to another network interface controller of the network adapter.

5. The backplane of claim 3:
respective units comprising at least two computing devices; and
the network adapter connector configured to connect respective computing devices of respective units with one network through one network interface controller.

6. The backplane of claim 3:
the network adapter comprising at least two network interface controllers connected to one network; and
the network adapter connector configured to connect at least one unit to the network through at least two network interface controllers.

7. The backplane of claim 1:
respective backplane connectors comprising at least two backplane connector lanes connecting to the unit connector of the unit;
the backplane bus comprising, for respective backplane connectors, at least two bus lanes connecting to the at least two backplane connector lanes of the backplane connector; and
the network adapter connector connecting the at least two bus lanes of the backplane bus with the network adapter.

8. The backplane of claim 7:
the network adapter comprising at least one network adapter lane; and
the network adapter connector configured to, upon connecting with a network adapter:
determine a network adapter lane count of the network adapter lanes of the network adapter; and
negotiate an active lane count comprising a lesser of the network adapter lane count and a backplane bus lane count of the backplane bus lanes of the backplane bus.

9. The backplane of claim 8:
the network adapter comprising a network interface controller having a bandwidth; and
the active lane count associated with the bandwidth of the network adapter.

10. The backplane of claim 8:
the network adapter comprising at least one network interface controller; and
the active lane count associated with a network interface controller count of the network interface controllers of the network adapter.

11. The backplane of claim 1, further comprising: a network adapter switch connecting the backplane bus and the network adapter connector, the network adapter switch configured to share the network adapter with the at last two units.

12. The backplane of claim 11, the network adapter switch configured to share the network adapter with the at least two units.

13. The backplane of claim 1, further comprising: a unit interconnect connecting the backplane bus and the network adapter connector, the unit interconnect configured to enable communication among the at least two units.

14. The backplane of claim 1:
at least one unit comprising a unit network connector configured to exchange data according to a network protocol; and
the backplane connector configured to translate between the network protocol of the unit network connector and the expansion bus protocol.

15. The backplane of claim 1, the backplane bus comprising a set of traces connecting the backplane connectors and the network adapter connector.

16. The backplane of claim 15:
the network adapter comprising at least two network interface controllers; and
respective traces connecting one unit through the network adapter connector with one network interface controller.

17. The backplane of claim 15, the traces having a trace length that is shorter than a trace repeater threshold.

18. A computing unit enclosure comprising:
at least two units respectively comprising a unit connector;
at least one network adapter connected to at least one network; and
a backplane comprising:
at least two backplane connectors respectively configured to connect to a unit connector of a unit;
a backplane bus connected to the backplane connectors and configured to exchange data with the backplane connectors according to an expansion bus protocol; and
a network adapter connector connecting the backplane bus and the at least one network adapter, and configured to exchange data with the at least one network adapter according to the expansion bus protocol.

19. The computing unit enclosure of claim 18, further comprising: a computing unit enclosure interconnect configured to connect at least one unit of the computing unit enclosure with at least one unit of a second computing unit enclosure.

20. A computing unit enclosure comprising:
at least two units respectively comprising a unit connector and at least two computing devices;
at least one network adapter respectively comprising at least two network interface controllers respectively comprising at least one network adapter lane and connected to a network, and configured to connect respective computing devices of respective units with a network through a network interface controller;
a backplane comprising:
at least two backplane connectors respectively configured to connect to a unit connector of a unit, respective backplane connectors comprising at least two backplane connector lanes;
a backplane bus connected to the backplane connectors of respective units through at least two bus lanes, and configured to exchange data with the backplane connectors according to a Peripheral Component Interconnect Express (PCI-Express) expansion bus protocol, respective bus lanes comprising a set of traces connecting the backplane connectors and the network adapter connector, respective traces having a trace length that is shorter than a trace repeater threshold;
a network adapter connector connecting the at least two bus lanes of the backplane bus and the at least one network adapter, and configured to:
upon connecting with a network adapter:
determine a network adapter lane count of the network adapter lanes of the network adapter; and
negotiate an active lane count comprising a lesser of the network adapter lane count and a backplane bus lane count of the backplane bus lanes of the backplane bus; and
exchange data with the at least one network adapter according to the expansion bus protocol;
a network adapter switch configured to share the network adapter with the at least two units; and
a unit interconnect connecting the backplane bus and the network adapter connector, the unit interconnect configured to enable communication among the at least two units; and
a computing unit enclosure interconnect configured to connect at least one unit of the computing unit enclosure with at least one unit of a second computing unit enclosure.
